(19) United States
(12) Patent Application Publication
(10) Pub. No.: US 2026/0260922 A1
(43) Pub. Date: Sep. 3, 2026

(54) ELECTRICAL POWER SOURCE

(71) Applicant: Primetals Technologies Germany GmbH, Erlangen (DE)

(72) Inventor: Klaus WEINZIERL, Nürnberg (DE)

(21) Appl. No.: 19/489,954

(22) PCT Filed: Jun. 6, 2024
(86) PCT No.: PCT/EP2024/065513

§ 371 Date: Dec. 4, 2025

(30) Foreign Application Priority Data
Jun. 7, 2023 (EP) 23177985.1

(51) Int. Cl. H01M 8/18; H01M 8/04007; H01M 8/04029; H01M 8/04082; H01M 8/04186; H01M 8/04276; H01M 8/2455

(52) U.S. Cl. CPC H01M 8/188; H01M 8/04029; H01M 8/04052; H01M 8/04186; H01M 8/04201; H01M 8/04276; H01M 8/2455

(57) ABSTRACT

An electrical power source that includes two flow batteries, which are held at different temperatures from one another and the potential difference of which can be tapped as useful voltage. Electrolyte liquids are conducted comprehensively across the two flow batteries. A heat store is additionally incorporated into the energy source and the electrolyte liquids are conducted through the heat store so that they have their respective temperatures on the input side of the respective flow batteries. The heat store is held in the upper region at the higher of the two temperatures by feed elements arranged in the upper region and in the lower region at the lower of the two temperatures by feed elements arranged in the lower region. The temperature profile therebetween is established in accordance with the state of charge of the heat store.

### TECHNICAL FIELD

The present invention relates to an electrical power source,
wherein the electrical power source comprises two flow batteries,
wherein the flow batteries each comprise first and second poles,
wherein the first poles are electrically connected to one another and a respective useful potential can be tapped at the second poles,
wherein the useful potentials have the same sign in relation to the first poles,
wherein the two flow batteries each comprise a reaction chamber,
wherein the reaction chambers each comprise a membrane that separates the respective reaction chamber into two fluid chambers,
wherein the membranes are permeable to a transition of electrical charge carriers between the fluid chambers of the respective reaction chamber,
wherein the electrical power source comprises two circuits separate from one another for a respective electrolyte liquid,
wherein the circuits are closed circuits, which each connect one of the fluid chambers of the two reaction chambers to one another, so that the electrolyte liquids alternately each flow through one of the fluid chambers of the one reaction chamber and one of the fluid chambers of the other reaction chamber,
wherein the two circuits comprise heat exchangers on the inlet side of the reaction chambers, by means of which the electrolyte liquids are brought to a respective temperature,
wherein one of the two temperatures is higher than the other.

### PRIOR ART

Electrical power sources are known in a wide variety of designs. Examples of such power sources are generators, photocells, batteries, accumulators, and the like.

A flow battery is known from the entry “Redox-Flow-Batterie [redox flow battery]” in the German Wikipedia, visited on 04.27.2023. A flow battery is an embodiment of an accumulator. In a flow battery, the electrical power is stored in chemical compounds, wherein the reaction partners are present in solvent in dissolved form. The electrical power is thus stored in electrolytes. The electrolytes are guided in two circuits separate from one another, wherein the ion exchange takes place in a galvanic cell by means of a membrane. The substances dissolved in the electrolytes are chemically reduced or oxidized in the cell, wherein electrical power is required to charge the flow battery and electrical power is released upon the discharge.

It is known from an entry in the Internet, which the applicant has visited on 04.26.2023 at the URL https://www.sandia.gov/ess/projects/batteries, that there are flow batteries in which the battery supplied by the voltage contains a noticeable temperature-dependent contribution, so that the battery voltage can be drastically changed simply by changing the temperature. It is explained that the flow battery can be kept at a low temperature during the charging portion of the battery cycle and at a high temperature during the discharging portion of the battery cycle and the amount of electrical power that can be supplied by the battery can be maximized in this way. It is proposed that the electrolyte liquids be pumped back and forth between storage tanks (obviously via the galvanic cell), wherein the storage tanks are kept at different temperatures.

An electrical power source according to the preamble of claim 1 is known from US 2019/0 252 697 A 1 . A similar disclosure content can be inferred from JP 2020 188 012 A.

An electrical power source which comprises a single flow battery is known from U.S. Pat. No. 7,820,321 B2 . The flow battery comprises a first and a second pole and a reaction chamber. A potential can be tapped at each of the two poles. The reaction chamber comprises a membrane which divides the reaction chamber into two fluid chambers, wherein the membrane is permeable to a transition of electrical charge carriers between the fluid chambers of the reaction chamber. Furthermore, the electrical power source comprises two closed circuits separate from one another for a respective electrolyte liquid.

### SUMMARY OF THE INVENTION

The object of the present invention is to specify a design of an electrical power source which comprises flow batteries and utilizes the temperature dependence of the battery voltages in an advantageous manner. An energy balance of the electrical power storage device is to be optimized in this case and furthermore influences on the thermal balance of the electrical power source, which occur during charging and during discharging, are to be able to be taken into consideration.

The object is achieved by an electrical power source having the features of claim 1. Advantageous embodiments of the electrical power source are the subject matter of dependent claims 2 to 4.

According to the invention, an electrical power source of the type mentioned at the outset is embodied in that
the electrical power source comprises a heat storage device in which a storage medium is located,
the heat exchangers each comprise a feed element and a removal element,
the respective feed element is kept at the respective temperature to which the respective electrolyte liquid is brought by means of the respective heat exchanger, in particular a respective fluid is guided through the respective feed element, which has the respective temperature when it is fed to the respective feed element,
the respective electrolyte liquid flows through the respective removal element,
the feed elements which are kept at the higher of the two temperatures are exclusively arranged in an upper area of the heat storage device and the feed elements which are kept at the lower of the two temperatures are exclusively arranged in a lower area of the heat storage device, and
the removal elements, by means of which the respective electrolyte liquid is brought to the higher of the two temperatures, are arranged at least in the upper area of the heat storage device and the removal elements, by means of which the respective electrolyte liquid is brought to the lower of the two temperatures, are arranged at least in the lower area of the heat storage device.

Influences on the thermal balance of the electrical power source which occur during charging and during discharging can thus be absorbed and buffered by the heat storage device.

In the simplest design, the electrical power source exclusively works as a power source, thus does not offer a storage option for electrical power. However, it is possible to design the electrical power source such that storage of electrical power is also possible. This is achieved in that the two circuits comprise storage vessels and influencing elements on the outlet side of the reaction chambers, by means of which the amount of respective electrolyte liquid is adjustable, which is transported from the storage vessel on the outlet side of the reaction chamber of the one flow battery via the heat exchanger on the inlet side of the reaction chamber of the other flow battery and the reaction chamber of the other flow battery into the storage vessel on the outlet side of the reaction chamber of the other flow battery, so that a fill level of the storage vessel on the outlet side of the reaction chamber of the one flow battery decreases and a fill level of the storage vessel on the outlet side of the reaction chamber of the other flow battery increases.

The influencing elements can be pumps. This design is always implementable. In the case of pumps, the amount of electrolyte liquid transported in each case can be set by the corresponding actuation of the pumps. Alternatively, two of the influencing elements can each be pumps and valves. This design is implementable if there is a height difference between the storage vessels on the inlet side and outlet side of the valves, so that the respective electrolyte liquid, when the respective valve is open, already flows due to gravity from the storage vessel on the inlet side of the respective valve via the reaction chamber on the outlet side of the respective valve into the storage vessel the outlet side of the mentioned reaction chamber. The amount of flowing electrolyte liquid can be set in this case by the extent to which the respective valve is opened.

Preferably, the feed elements which are kept at the higher of the two temperatures are combined to form a common feed element and the feed elements which are kept at the lower of the two temperatures are also combined to form a common feed element. The overall design of the electrical power source is thus simplified. Of course, the removal elements have to remain separate from one another at least with respect to the electrolyte flows, since otherwise separate circuits would no longer be present. In a mechanical-design aspect, they can possibly also be combined.

It is preferably provided that
the removal elements extend within the heat storage device from the upper area of the heat storage device to the lower area of the heat storage device,
the respective electrolyte liquid flows through the removal elements by means of which the respective electrolyte liquid is brought to the higher of the two temperatures from bottom to top within the heat storage device, and
the respective electrolyte liquid flows through the removal elements by means of which the respective electrolyte liquid is brought to the lower of the two temperatures from top to bottom within the heat storage device.

The efficiency of the heat storage device is maximized by this design.

### BRIEF DESCRIPTION OF THE DRAWINGS

The above-described properties, features, and advantages of this invention and the manner in which they are achieved will become clearer and more comprehensible in conjunction with the following description of an exemplary embodiment, which is explained in more detail in conjunction with the drawings. In the figures:

FIG. 1 shows an electrical power source,

FIG. 2 shows a further electrical power source, and

FIG. 3 shows temperature profiles.

### DESCRIPTION OF THE EMBODIMENTS

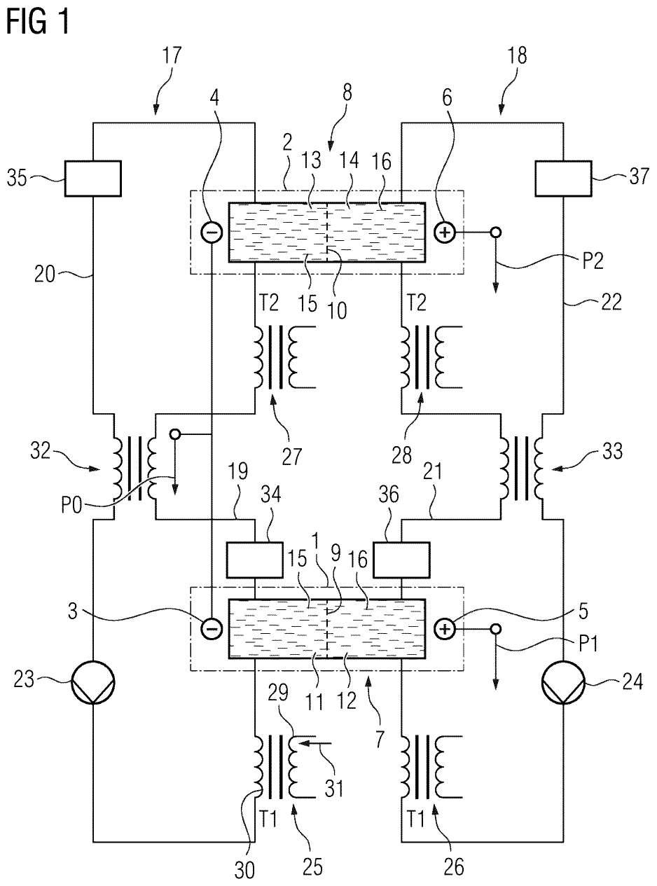

According to FIG. 1, an electrical power source comprises two flow batteries 1, 2. The two flow batteries 1, 2 each comprise first poles 3, 4 and second poles 5, 6. The first poles 3, 4 are electrically connected to one another. A respective useful potential P1, P2 can be tapped at the second poles 5, 6. The two useful potentials P1, P2 have the same sign in relation to the first poles 3, 4 (or the corresponding common potential P0). According to the illustration in FIG. 1, the two useful potentials P1, P2 are positive, thus greater than the common potential P0. However, this could also be reversed.

The two flow batteries 1, 2 furthermore each comprise a reaction chamber 7, 8. The reaction chambers 7, 8 each comprise a membrane 9, 10. The respective membrane 9, 10 separates the respective reaction chamber 7, 8 into two fluid chambers 11, 12 or 13, 14. The membranes 9, 10 are permeable to a transition of electrical charge carriers between the fluid chambers 11, 12 or 13, 14 of the respective reaction chamber 7, 8. In contrast, they are not permeable to electrolyte liquids 15, 16 located in the fluid chambers 11 to 14.

The electrical power source furthermore comprises two circuits 17, 18 separate from one another. The two circuits 17, 18 are closed circuits. One of the two electrolyte liquids 15, 16 circulates in each them. The one circuit 17 connects the fluid chambers 11 and 13 to one another. The connection is such that the electrolyte liquid 15 is initially guided via a line section 19 from the fluid chamber 11 to the fluid chamber 13 and then via a line section 20 from the fluid chamber 13 to the fluid chamber 11. The other circuit 18 connects the fluid chambers 12 and 14 to one another. The connection is such that the electrolyte liquid 16 is initially guided via a line section 21 from the fluid chamber 12 to the fluid chamber 14 and is then guided via a line section 22 from the fluid chamber 14 to the fluid chamber 12. As a result, the electrolyte liquids 15, 16 alternately each flow through one of the fluid chambers 11, 12 of one reaction chamber 7 and one of the fluid chambers 13, 14 of the other reaction chamber 8. Pumps 23, 24 required to convey the electrolyte liquids 15, 16 are always both operated identically. They can in principle be arranged at arbitrary points of the circuits 17, 18. The arrangement shown in the line sections 20 and 22 is not obligatory. They could also likewise be arranged in the line sections 19 and 21.

When the electrolyte liquid 15 flows through the fluid chamber 11, it is either oxidized or reduced. When the electrolyte liquid 15 is oxidized in the fluid chamber 11, the electrolyte liquid 16 is reduced in the fluid chamber 12, the electrolyte liquid 15 is reduced in the fluid chamber 13, and the electrolyte liquid 16 is oxidized in the fluid chamber 14. In contrast, if the electrolyte liquid 15 is reduced in the fluid chamber 11, the electrolyte liquid 16 is oxidized in the fluid chamber 12, the electrolyte liquid 15 is oxidized in the fluid chamber 13, and the electrolyte liquid 16 is reduced in the fluid chamber 14.

The two circuits 17, 18 comprise heat exchangers 25 to 28 on the inlet side of the reaction chambers 7, 8. The electrolyte liquids 15, 16 are brought to a temperature T1 by means of the heat exchangers 25 and 26. The electrolyte liquids 15, 16 are brought to a temperature T2 by means of the heat exchangers 27 and 28. The temperature T2 is higher than the temperature T1.

The structure of the heat exchanger 25 is explained in more detail hereinafter. Analogous statements apply to the other heat exchangers 26 to 28.

According to FIG. 1, the heat exchanger 25 comprises a feed element 29 and a removal element 30. The feed element 29 is kept at the temperature T1, thus at the temperature to which the electrolyte liquid 15 is brought by means of the heat exchanger 25. In particular, it is possible that for this purpose a fluid 31 is guided through the feed element 29 which has the temperature Tl when it is fed to the feed element 29. The removal element 30 is a component of the circuit 17. The electrolyte liquid 15 flows through it. The feed element 29 and the removal element 30 are thermally coupled with one another, so that the temperature Tl of the feed element 29 is transferred to the electrolyte liquid 15.

To be able to supply different potentials P1, P2 as a result, the potentials P1, P2, in relation to the common potential P0, have to depend to a noticeable extent on the temperature T1, T2 in the respective reaction chamber 7, 8. Corresponding electrolyte liquids 15, 16 are known. The electrolyte liquids which are used in a vanadium redox accumulator are mentioned solely by way of example.

In the design of FIG. 1, the two circuits 17, 18 comprise further heat exchangers 32, 33 between the heat exchangers 25 to 28 arranged on the inlet side of the reaction chambers 7, 8 of the flow batteries 1, 2 and the reaction chamber 8, 7 of the respective other flow battery 2, 1. The temperatures of the electrolyte liquids 15, 16 of the respective circuit 17, 18 are approximated to one another by means of the further heat exchangers 32, 33. For this purpose, on the one hand, the electrolyte liquid 15 which flows in the line section 19 from the reaction chamber 7 to the reaction chamber 8 and, on the other hand, the electrolyte liquid 15 which flows in the line section 20 from the reaction chamber 8 to the reaction chamber 7 flow through the heat exchanger 32. In a similar manner, for this purpose, on the one hand, the electrolyte liquid 16 which flows in the line section 21 from the reaction chamber 7 to the reaction chamber 8 and, on the other hand, the electrolyte liquid 16 which flows in the line section 22 from the reaction chamber 8 to the reaction chamber 7 flow through the heat exchanger 33.

Furthermore, storage vessels 34 to 37 at the outlet side of the reaction chambers 7, 8 are shown in FIG. 1. The storage vessels 34 to 37 are components of the circuits 17, 18.

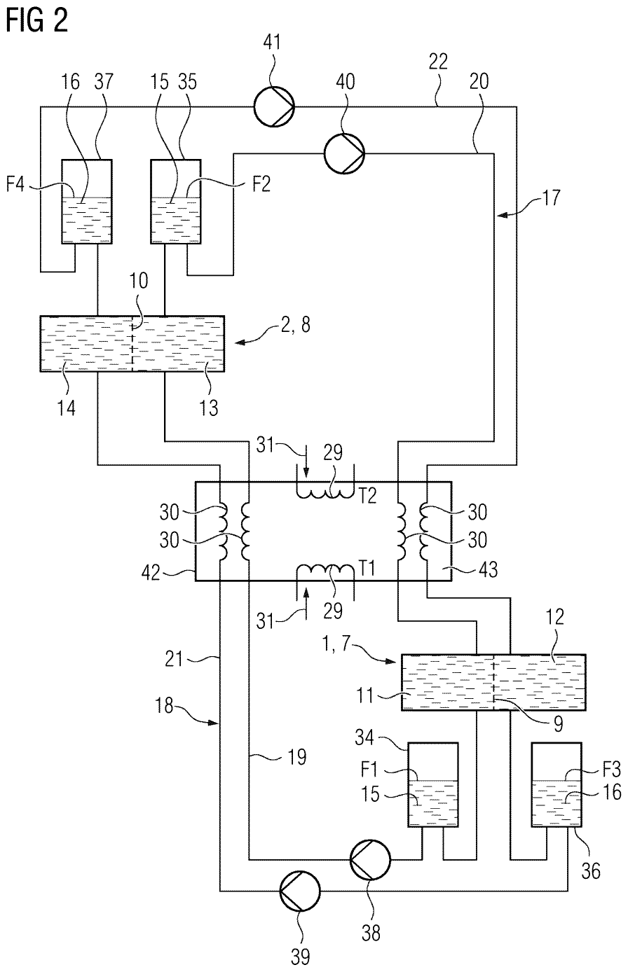

A design according to the invention of an electrical power source will be explained hereinafter in conjunction with FIG. 2. The above explanations made in conjunction with FIG. 1 also apply to this design. In FIG. 2, however, the poles 3 to 6 and also the potentials P0, P1, and P2 are not shown, since they are not necessary to understand the modifications of the design of FIG. 2 in relation to the design of FIG. 1.

The storage vessels 34 to 37 are also present on the outlet side of the reaction chambers 7, 8 in the design according to FIG. 2. Furthermore, the two circuits 17, 18—instead of the pumps 23, 24—comprise influencing elements 38 to 41 on the outlet side of the reaction chambers 7, 8. The influencing elements 38 to 41 can be arranged downstream from the storage vessels 34 to 37 corresponding to the illustration in FIG. 2. Alternatively, the influencing elements 38 to 41 can be arranged upstream from the storage vessels 34 to 37.

The influencing elements 38 to 41 can be operated jointly and identically. In this case, the electrical power source operates in the same manner as explained above in conjunction with FIG. 1. However, the influencing elements 38 to 41 may also only be operated identically in pairs. In particular, the influencing elements 38 and 39 are always operated jointly and identically and the influencing elements 40 and 41 are also always operated jointly and identically. However, the operation of the influencing elements 38 and 39, on the one hand, can be selected independently of the operation of the influencing elements 40 and 41.

It will initially be explained hereinafter what takes place when exclusively the influencing element 38 and the influencing element 39 are operated.

In this case, by means of the influencing element 38, the electrolyte liquid 15 is transported from the storage vessel 34 on the outlet side of the reaction chamber 7 via the removal element 30 of the heat exchanger 27 (cf. FIG. 1) on the inlet side of the reaction chamber 8 and the reaction chamber 8 itself into the storage vessel 35. A fill level F1 of the storage vessel 34 thus decreases. A fill level F2 of the storage vessel 35 increases to the same extent. Analogously, the electrolyte liquid 16 is transported by means of the influencing element 39 from the storage vessel 36 on the outlet side of the reaction chamber 7 via the removal element 30 of the heat exchanger 28 (cf. FIG. 1) on the inlet side of the reaction chamber 8 and the reaction chamber 8 itself into the storage vessel 37. A fill level F3 of the storage vessel 36 thus decreases. A fill level F4 of the storage vessel 37 increases to the same extent. As a result, the flow battery 2 is therefore operated, but not the flow battery 1. The state of charge of the electrical power source is thus reduced. Charge is thus removed from the electrical power source.

The inverse procedure takes place when the influencing elements 40 and 41 are operated. The state of charge of the electrical power source is thus increased. Charge is thus fed to the electrical power source.

The expansion of the basic principle by the storage vessels 34 to 37 and the influencing elements 38 to 41 thus causes the electrical power source-in addition to a pure electrical power source-to also be able to be used as an electrical power storage device.

The electrical power source is therefore operable in three “pure” operating modes. In the first of these “pure” operating modes, all four influencing elements 38 to 41 are operated identically. This “pure” operating mode is in essence also the operating mode of the electrical power source of FIG. 1. In the second of these “pure” operating modes, exclusively the influencing elements 38 and 39 are operated, specifically identically. The influencing elements 40 and 41 are not operated in this operating mode. In the third of these “pure” operating modes it is the reverse. Exclusively the influencing elements 40 and 41 are operated here, specifically identically. The influencing elements 38 and 39 are not operated in this operating mode. These two further “pure” operating modes are possible in the electrical power source of FIG. 2, but not in the electrical power source of FIG. 1. In addition to these “pure” operating modes, mixed operation is also possible in the electrical power sour of FIG. 2, in which all four influencing elements 38 to 41 are operated, but the influencing elements 38 and 39 are actuated more strongly or weakly than the influencing elements 40 and 41.

In the illustration according to FIG. 2, all four influencing elements 38 to 41 are designed as pumps. However, two of the influencing elements 38 to 41 can possibly also each be designed as pumps and as valves. This design is not shown separately. To optimize the thermal energy balance, the electrical power source according to the illustration in FIG. 2 furthermore comprises a heat storage device 42. A storage medium 43 is located in the heat storage device 42, for example, a thermal oil or water or a salt melting at a low temperature, for example, sodium acetate trihydrate, sodium sulfate, sodium hydroxide, or alum. The melting point of the storage medium 43 can be between the two temperatures T1, T2. The melting point of the storage medium 43 can also be below the temperature T1, however. Furthermore, a boiling temperature of the storage medium 43 is to be above the temperature T2 if possible. However, exceptions to these rules are possible.

In the design according to FIG. 2, the feed elements 29 which are kept at the temperature T2 are exclusively arranged in an upper area of the heat storage device 42. Vice versa, the feed elements 29 which are kept at the temperature T1 are exclusively arranged in a lower area of the heat storage device 42. The removal elements 30, by means of which the electrolyte liquids 15, 16 are brought to the temperature T2, are arranged at least in the upper area of the heat storage device 42. Vice versa, the removal elements 30 by means of which the electrolyte liquids 15, 16 are brought to the temperature T1 are arranged at least in the lower area of the heat storage device 42.

Preferably, the removal elements 30 are not exclusively arranged in the upper or the lower area of the heat storage device 42, but rather extend according to the illustration in FIG. 2 within the heat storage device 42 from the upper area of the heat storage device 42 to the lower area of the heat storage device 42. In this case, the electrolyte liquids 15, 16 flow through the removal elements 30, by means of which the electrolyte liquids 15, 16 are brought to the temperature T2, from bottom to top within the heat storage device 42. Vice versa, in this case the electrolyte liquids 15, 16 flow through the removal elements 30, by means of which the electrolyte liquids 15, 16 are brought to the temperature T1, from top to bottom within the heat storage device 42.

According to the illustration in FIG. 2, furthermore the feed elements 29 which are kept at the temperature T2 are combined to form a common feed element. Likewise, the feed elements 29 which are kept at the temperature Tl are also combined to form a common feed element.

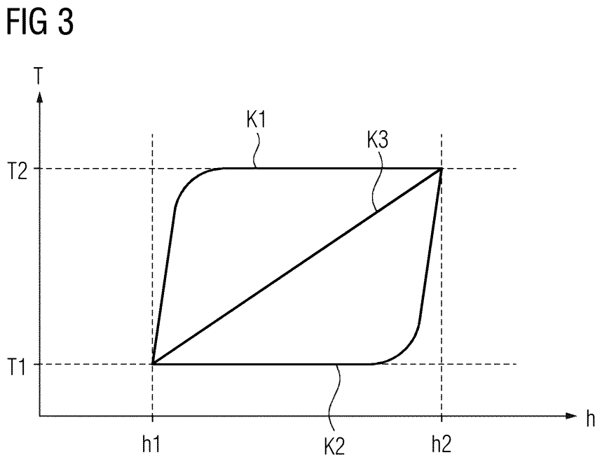

In an electrical power source which comprises a heat storage device 42, the temperature layering of the storage medium 43 in the heat storage device 42 depends on the extent to which the electrical power source is charged or discharged. This will be explained hereinafter in conjunction with FIG. 3, in which the temperature of the storage medium 43 is shown as a function of the height h within the heat storage device 42.

In FIG. 3, the lowest point of the heat storage device 42 is designated by h1 and the highest point is designated by h2. In the lower area of the heat storage device 42, thus at the location of the corresponding feed element 29, the storage medium 43 always has the temperature T1. Analogously, the storage medium 43 always has the temperature T2 in the upper area of the heat storage device 42, thus at the location of the corresponding feed element 29. The temperature profile therebetween depends, however, on whether the electrical power source is charged or discharged. If the electrical power source is fully charged, the fill levels F1 and F3 are maximal and the fill levels F2 and F4 are minimal. In this case, a temperature profile approximately corresponding to the curve K1 results. The thermal energy is essentially located in the heat storage device 42. If the electrical power source is fully discharged, the fill levels F1 and F3 are minimal and the fill levels F2 and F4 are maximal. In this case, a temperature profile approximately corresponding to the curve K2 results. The thermal energy is essentially located in the electrolyte liquids 15, 16. If the electrical power source is neither fully charged nor fully discharged, a temperature profile between the curves K1 and K2 results, for example, approximately corresponding to the curve K3. The fill levels F1 to F4 are also between their minimum and maximum values.

The present invention has many advantages. In particular, in a simple manner-namely without a detour via a heat engine which drives a generator-electrical power can be generated on the basis of a temperature difference. The mode of operation is similar to the Carnot cycle. The electrical power source-at least in some cases-can still supply electrical power even if the operation of a heat engine having corresponding temperature differences would no longer be possible. In the case of the design according to FIG. 2, furthermore storage and discharge of electrical power are also possible. Furthermore, it is possible to switch between the various operating modes very quickly, thus highly dynamically. Furthermore, such flow batteries 1, 2 can also be cascaded and further loops having heat exchangers 25 to 28 can be installed in the heat storage device 42 in order also to be able to bring the electrolytes 15, 16 to their respective target temperature T1 or T2 again and again even with repeated passages through flow batteries 1, 2. Although the invention was illustrated and described in more detail by the preferred exemplary embodiments, the invention is not restricted by the disclosed examples and other variations can be derived therefrom by a person skilled in the art without departing from the scope of protection of the invention.

### LIST OF REFERENCE SIGNS

1, 2 flow batteries
3 to 6 poles
7, 8 reaction chambers
9, 10 membranes
11 to 14 fluid chambers
15, 16 electrolyte liquids
17, 18 circuits
19 to 22 line sections
23, 24 pumps
25 to 28 heat exchangers
29 feed element
30 removal element
31 fluid
32, 33 further heat exchangers
34 to 37 storage vessels
38 to 41 influencing elements
42 heat storage device
43 storage medium
F1 to F4 fill levels
h, h1, h2 heights
K1, K2, K3 curves
P0, P1, P2 potentials
T1, T2 temperatures

1. An electrical power source,
wherein the electrical power source comprises two flow batteries,
wherein the flow batteries each comprise first and second poles,
wherein the first poles are electrically connected to one another and a respective useful potential can be tapped at the second poles
wherein the useful potentials, in relation to the first poles, have the same sign,
wherein the two flow batteries each comprise a reaction chamber,
wherein the reaction chambers each comprise a membrane, which separates the respective reaction chamber into two fluid chambers.
wherein the membranes are permeable to a transition of electrical charge carriers between the fluid chambers of the respective reaction chamber
wherein the electrical power source comprises two circuits, separate from one another for a respective electrolyte liquid,
wherein the circuits are closed circuits, which each connect one of the fluid chambers of the two reaction chambers to one another, so that the electrolyte liquids alternately each flow through one of the fluid chambers of the one reaction chamber and one of the fluid chambers of the other reaction chamber,
wherein the two circuits comprise heat exchangers on the inlet side of the reaction chambers, by means of which the electrolyte liquids are brought to a respective temperature,
wherein one of the two temperatures is higher than the other,
wherein the electrical power source comprises a heat storage device, in which a storage medium is located,
wherein the heat exchangers each comprise a feed element and a removal element,
wherein the respective feed element is kept at the respective temperature, to which the respective electrolyte liquid is brought by means of the respective heat exchanger, in particular a respective fluid is guided through the respective feed element, which has the respective temperature when fed to the respective feed element,
wherein the respective electrolyte liquid flows through the respective removal element,
wherein the feed elements which are kept at the higher of the two temperatures,
are exclusively arranged in an upper area of the heat storage device and the feed elements which are kept at the lower of the two temperatures are exclusively arranged in a lower area of the heat storage device, and
wherein the removal elements, by means of which the respective electrolyte liquid is brought to the higher of the two temperatures, are arranged at least in the upper area of the heat storage device and the removal elements, by means of which the respective electrolyte liquid is brought to the lower of the two temperatures, are arranged at least in the lower area of the heat storage device.

2. The electrical power source as claimed in claim 1, wherein
the two circuits comprise storage vessels and influencing elements on the outlet side of the reaction chambers, by means of which the amount of respective electrolyte liquid is settable, which is transported from the storage vessel on the outlet side of the reaction chamber of the one flow battery via the heat exchanger on the inlet side of the reaction chamber of the other flow battery and the reaction chamber of the other flow battery into the storage vessel on the outlet side of the reaction chamber of the other flow battery, so that a fill level of the storage vessel on the outlet side of the reaction chamber of the one flow battery decreases and a fill level of the storage vessel on the outlet side of the reaction chamber of the other flow battery increases.

3. The electrical power source as claimed in claim 1, wherein
the feed elements which are kept at the higher of the two temperatures are combined to form a common feed element and the feed elements which are kept at the lower of the two temperatures are combined to form a common feed element.

4. The electrical power source as claimed in claim 1, wherein
the removal elements extend inside the heat storage device from the upper area of the heat storage device to the lower area of the heat storage device,
the respective electrolyte liquid flows through the removal elements, by means of which the respective electrolyte liquid is brought to the higher of the two temperatures, from bottom to top within the heat storage device, and
the respective electrolyte liquid flows through the removal elements, by means of which the respective electrolyte liquid is brought to the lower of the two temperatures, from top to bottom within the heat storage device.
